(19) United States
(12) Patent Application Publication
(10) Pub. No.: US 2026/0018005 A1
(43) Pub. Date: Jan. 15, 2026

(54) SYSTEM AND METHOD FOR CONTINUOUS POLLING OF NETWORKED USERS

(71) Applicant: MotherDAO Labs Inc., Cheyenne, WY (US)

(72) Inventors: Andrew Reuben Lawrence FURMANCZYK, Prince George (CA); Carl Oscar AARO, Uppsala (SE)

(73) Assignee: MotherDAO Labs Inc., Cheyenne, WY (US)

(21) Appl. No.: 19/268,362

(22) Filed: Jul. 14, 2025

Related U.S. Application Data
(60) Provisional application No. 63/671,458, filed on Jul. 15, 2024.

(51) Int. Cl. G07C 13/00; H04L 9/40

(52) U.S. Cl. CPC G07C 13/00; H04L 63/0807; H04L 63/0823

(57) ABSTRACT

A method for continuous polling of networked users. An account associated with a user device is verified to determine whether the account has access to a poll. On a condition that the account is verified, the account is granted access to a ballot, wherein the ballot is a copy of the poll specific to the account. A selection of one or more options in the ballot is received from the user device. The results of all active ballots are tallied at intervals into an aggregated ballot, wherein an active ballot is a most recently submitted ballot of each verified voter. The aggregated ballot is stored as a snapshot.

### CROSS-REFERENCE TO RELATED APPLICATIONS

This application claims priority to U.S. Provisional Patent Application No. 63/671,458, filed Jul. 15, 2024, entitled SYSTEM AND METHOD FOR CONTINUOUS POLLING OF NETWORKED USERS, which is hereby incorporated by reference in its entirety.

### BACKGROUND

A consensus polling mechanism allows individuals to vote on any number of options. For example, a ballot or poll may include multiple options that an individual can vote for. The poll may be tallied and results provided to the voters and to non-voters. A drawback to this approach is that the poll is usually open for a limited period of time. If the poll is to be conducted again at a later point in time, any voter who voted in the previous poll would need to vote again in the later poll to have their vote counted.

### SUMMARY

Some embodiments provide a non-transitory computer-readable medium storing instructions that are executable by one or more processors of a network system to perform operations for continuous polling of networked users. The operations include verifying whether an account associated with a user device has access to a poll. On a condition that the account is verified, the account is granted access to a ballot, wherein the ballot is a copy of the poll specific to the account. A selection of one or more options in the ballot is received from the user device. The results of all active ballots are tallied at intervals into an aggregated ballot, wherein an active ballot is a most recently submitted ballot of each verified voter. The aggregated ballot is stored as a snapshot.

Some embodiments provide a method for continuous polling of networked users includes: verifying whether an account associated with a user device has access to a poll; on a condition that the account is verified, granting the account access to a ballot, wherein the ballot is a copy of the poll specific to the account; receiving a selection of one or more options in the ballot from the user device; tallying results of all active ballots at intervals into an aggregated ballot, wherein an active ballot is a most recently submitted ballot of each verified voter; and storing the aggregated ballot as a snapshot.

Other advantages of the embodiments of the present disclosure will become apparent from the following description taken in conjunction with the accompanying drawings wherein are set forth, by way of illustration and example, certain embodiments of the present invention.

### BRIEF DESCRIPTION OF THE DRAWINGS

FIG. 1 is a block diagram of a system configured for continuous polling of networked users, according to some embodiments of the present disclosure.

FIG. 2 is a simplified block diagram of a user device, according to some embodiments of the present disclosure.

FIG. 3 is a simplified block diagram of a server, according to some embodiments of the present disclosure.

FIG. 4 is an example ballot, according to some embodiments of the present disclosure.

FIG. 5 is an example of a multi-layer ballot, according to some embodiments of the present disclosure.

FIG. 6 is an example of an aggregated ballot, according to some embodiments of the present disclosure.

FIGS. 7A and 7B are a flowchart of an exemplary method for creating an aggregated ballot snapshot, according to some embodiments of the present disclosure.

FIG. 8 is a flowchart of an exemplary method for aggregated ballot processing, according to some embodiments of the present disclosure.

### DETAILED DESCRIPTION

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses, systems, and methods consistent with aspects related to subject matter that may be recited in the appended claims.

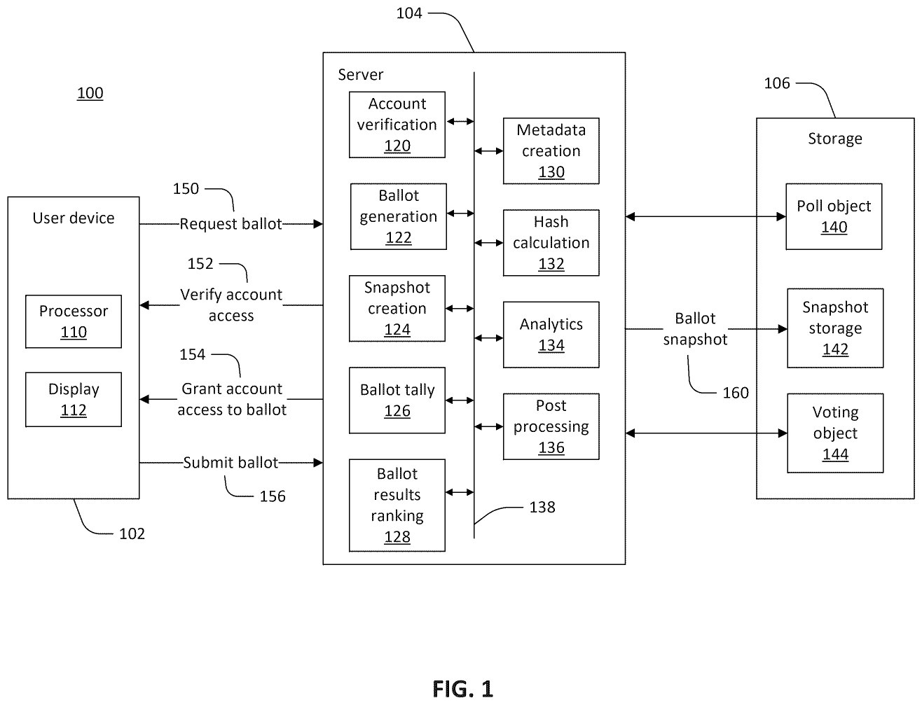

FIG. 1 is a block diagram of a system 100 configured for continuous polling of networked users, according to some embodiments of the present disclosure. In some embodiments, the system 100 includes a user device 102, a server 104, and a storage 106.

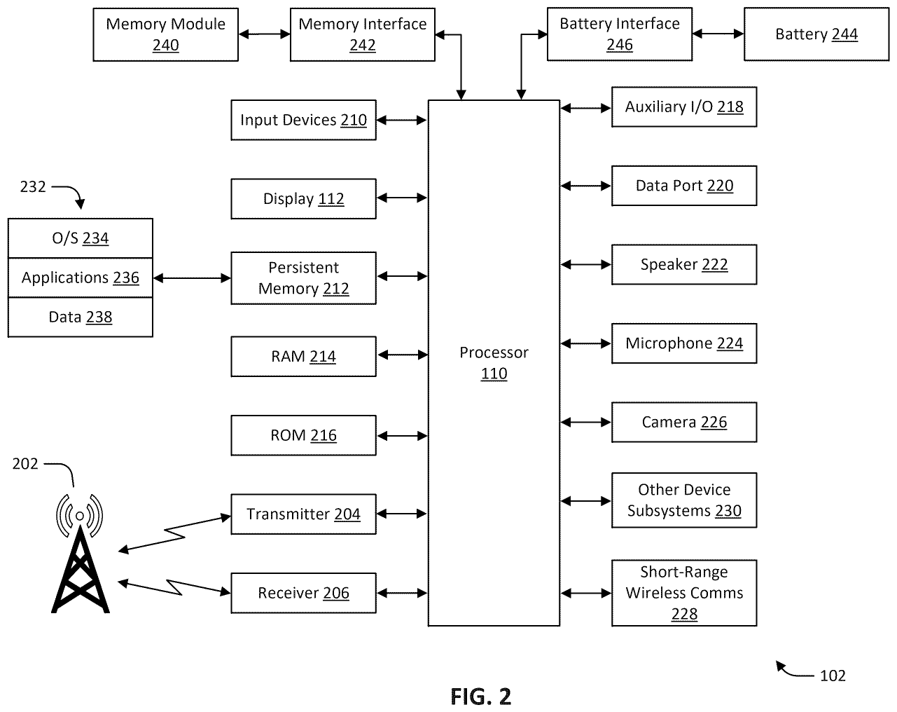

The user device 102 may include a processor 110 and a display 112. The processor 110 may include a central processing unit (CPU) with one or more processing cores, a graphics processing unit (GPU), a digital signal processor (DSP), a field programmable gate array (FPGA), an application specific integrated circuit (ASIC), or other processing device capable of executing instructions. The display 112 may include a liquid crystal display (LCD) screen, a light emitting diode (LED) screen, a touch-screen display, or any other appropriate display capable of displaying information to a user. It is noted that the user device 102 may include other components, as described in connection with FIG. 2. As used herein, the term “poll” refers to an object including, but not limited to, voting rules, a poll title, one or more parameters, a poll owner identifier, a current poll status (e.g., “open” or “closed”), and voting options. The term “ballot” refers to a voter's individual copy of the poll that includes one or more choices indicated by the voter and then signed by the voter.

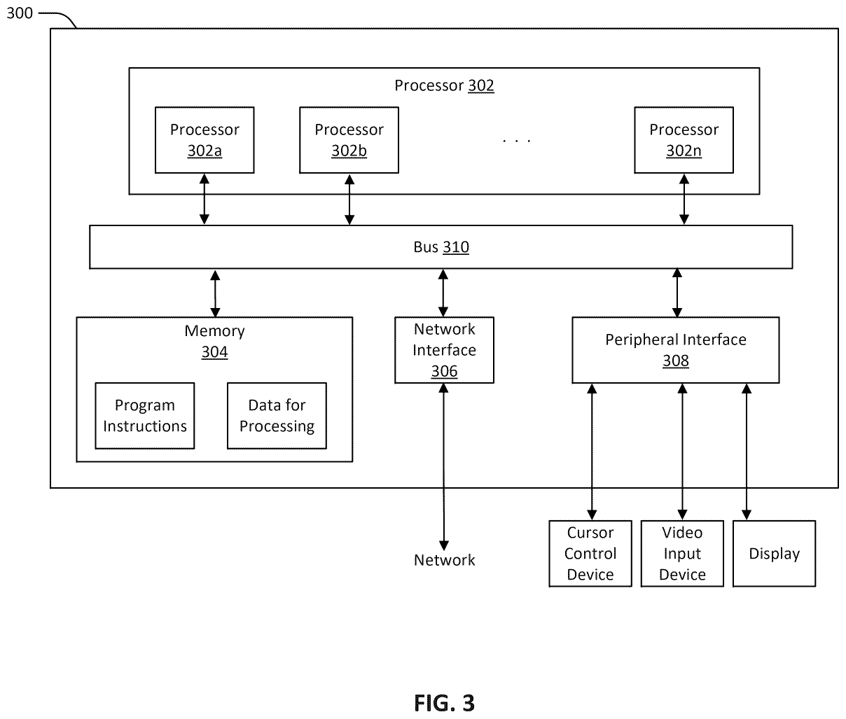

The server 104 may include an account verification component 120, a ballot generation component 122, a snapshot creation component 124, a ballot tally component 126, a ballot results ranking component 128, a metadata creation component 130, a hash calculation component 132, an analytics component 134, a post processing component 136, and an internal communications bus 138 that connects the components 120-136 and permits the components 120-136 to exchange data with each other. It is noted that the server 104 may include other components, as described in connection with FIG. 3. The components 120-136 may be implemented as hardware, software, or a combination of hardware and software. The server 104 may be part of a centralized network or a decentralized network. In some embodiments, the server 104 may be part of a network system including one or more networked devices.

The account verification component 120 is configured to verify whether an account has permission to access a poll. The ballot generation component 122 is configured to generate a ballot to be provided to a user or user device that owns the account or has access to the account. The snapshot creation component 124 is configured to create a periodic snapshot of all submitted ballots. The ballot tally component 126 is configured to calculate a tally of all submitted ballots at a time when the snapshot is taken. The ballot results ranking component 128 is configured to rank the results of the tallied ballots at the time when the snapshot is taken. The metadata creation component 130 is configured to create metadata corresponding to a ballot and to a snapshot. The hash calculation component 132 is configured to calculate a hash based on a submitted ballot and a snapshot. The analytics component 134 is configured to perform analytics on a snapshot. The post processing component 136 is configured to perform one or more actions based on the results of a ballot as contained in the snapshot. It is noted that while the components 120-136 are described as separate elements, the functionality of the components 120-136 may be combined or may be further separated without departing from the scope of the present disclosure.

The storage 106 may include a disk-based or a solid state drive-based storage external to the server 104 (as shown in FIG. 1), a disk-based or a solid state drive-based storage internal to the server 104, or a cloud-based storage external to the server 104 and accessible via a communications network (not shown in FIG. 1). The storage 106 may include poll object storage 140, snapshot storage 142, and voting object storage 144. The poll object storage 140 is configured to store different polls, including data and attributes of each poll. For example, a poll object may include (but is not limited to) an owner address (e.g., an address of a token or a certificate held by the poll owner or other mechanism to prove ownership of the poll), an address (e.g., a location) of a most recent snapshot for the poll, a snapshot frequency, a poll identifier, a poll version number, a public/private indicator (e.g., a flag or similar indicator), an encryption key if the poll is a private poll (e.g., an encryption/decryption key pair), a poll status (e.g., active, closed, paused, draft, or deleted), and the poll options to be voted on. A “paused” poll retains its previous results, but no new voting can take place and no new snapshots are generated while the poll remains in the paused status. A paused poll can be changed to the active status and voting and snapshot generation will resume. It is noted that the poll object may include additional information or different information within the scope of the present disclosure. The snapshot storage 142 is configured to store snapshots, as will be described elsewhere in this disclosure. The voting object storage 144 is configured to store different voting objects, including rules for counting the votes, rules for determining voting decay, voting token weight, a list of tokens that are eligible to vote, and a voting object identifier. It is noted that the voting object may include additional information or different information within the scope of the present disclosure. In some embodiments, a voting object may be associated with a corresponding poll object. For example, the rules for processing a submitted ballot may be maintained separately from the content of the ballot (e.g., where a ballot is an instance of a poll that is sent to a voter to be completed).

In some embodiments, the user device 102, the server 104, and the storage 106 may interact as follows. A user of the user device 102 may request a ballot from the server 104 (operation 150). In some embodiments, the server 104 may “push” a ballot to the user device 102.

Before providing the ballot to the user device 102, the server 104 verifies whether the account owned by the user or the user device has permission to access the ballot (operation 152). In some embodiments, the account may be verified by the account verification component 120. In some embodiments, the user or user device may be verified by determining whether the user or the user device 102 possesses a token (relating to the account) that grants access to the ballot. For example, the account verification component 120 may access the poll object storage 140 or the voting object storage 144 to determine which account tokens are eligible to vote in the requested poll. In some embodiments, the token may be a token or a certificate stored in a centralized or decentralized database. In some embodiments, the token may be stored on a blockchain or other type of distributed ledger technology. In some embodiments, an electronic mail address, phone number, user name, and/or password may be used instead of an account token to determine whether the user can access the ballot.

After the account is verified, the server 104 grants the account access to the ballot (operation 154). Continuing the example from above, if the user or the user device 102 possesses an eligible token to vote in the requested poll, then the user or the user device may be granted access to the poll. In some embodiments, the user device 102 may receive the ballot from the server 104 or the user device 102 may be able to access the ballot via a connection to the server 104, such as through an Internet connection. In some embodiments, the ballot may be generated by the ballot generation component 122. For example, a ballot specific to the user (e.g., including a voter identifier that identifies the voter for the specific poll) may be generated by the ballot generation component 122.

In some embodiments, a poll may be an “open poll” which may be viewed and accessed by any user. In such circumstances, the user requesting the ballot may be granted access to the ballot without verifying the user's account (e.g., operation 152 may be skipped).

After accessing the ballot, the user may vote on the options in the ballot and then submit the ballot for processing by the server 104 (operation 156). In some embodiments, the token or certificate related to the user's account may be used to control whether the user is eligible to vote on certain options in the poll. For example, a user with token “A” may be eligible to vote on all options in a poll while a user with token “B” may be eligible to vote on only some of the options in the poll. An indication of which tokens are eligible to vote for which options may be stored in the voting object, the poll object, a combination of the voting object and the poll object, or other storage location.

In some embodiments, a submitted ballot may also be referred to as a “voter ranked submission.” In some embodiments, when the user submits the ballot, the processor 110 adds a voter signature and a timestamp of the ballot submission to the ballot before sending the ballot from the user device 102 to the server 104. After the ballot is submitted by the user (meaning that the user has voted on one or more options in the ballot and has submitted the ballot for processing), the snapshot creation component 124 is configured to create a snapshot of all submitted ballots at a predetermined point in time. For example, the poll owner may determine that snapshots are taken on a periodic basis, such as hourly, daily, or weekly. It is noted that ownership of a poll may be transferred from the poll creator (the original poll owner) to another owner. For example, poll ownership may be transferred by transferring an ownership token or an ownership certificate from one entity or individual to another entity or individual. The poll owner at a given point in time may be determined to be the current owner of the poll ownership token.

In some embodiments, only submitted ballots are considered for inclusion in the snapshot. For example, if 100 people requested or received ballots and only 50 people submitted the ballot (e.g., voted on the options in the ballot), then only the 50 submitted ballots will be included in the snapshot. In some embodiments, the poll may remain “open” for voting for a predetermined period of time that spans multiple snapshots. For example, a poll may be open for one week and snapshots may be taken on an hourly or daily basis, to enable the interim results to be viewed on an ongoing basis, based on the periodicity of the snapshots. For example, if a poll is private, all accounts that are eligible to vote may view the snapshots. As another example, if a poll is public, anyone may view the snapshots. Also, once a ballot is submitted and as long as the poll is open for voting, a voter may change their votes and the previously submitted ballot will no longer be counted and the changed votes will be counted (e.g., as a new active ballot for the voter) in the next snapshot following the time when the user submitted the new ballot. In some embodiments, a poll may be continuous (e.g., open for an indefinite period of time) and snapshots may be taken at different frequencies (e.g., hourly, daily, weekly, or monthly) to present a “stream” of preferences of the voters.

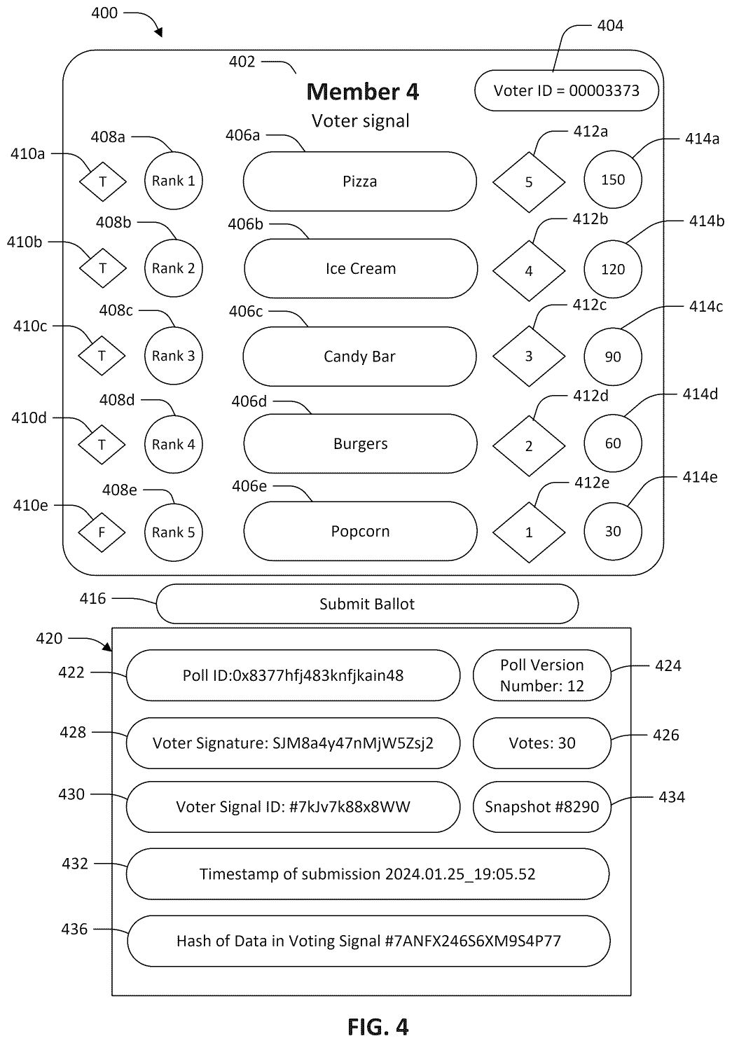

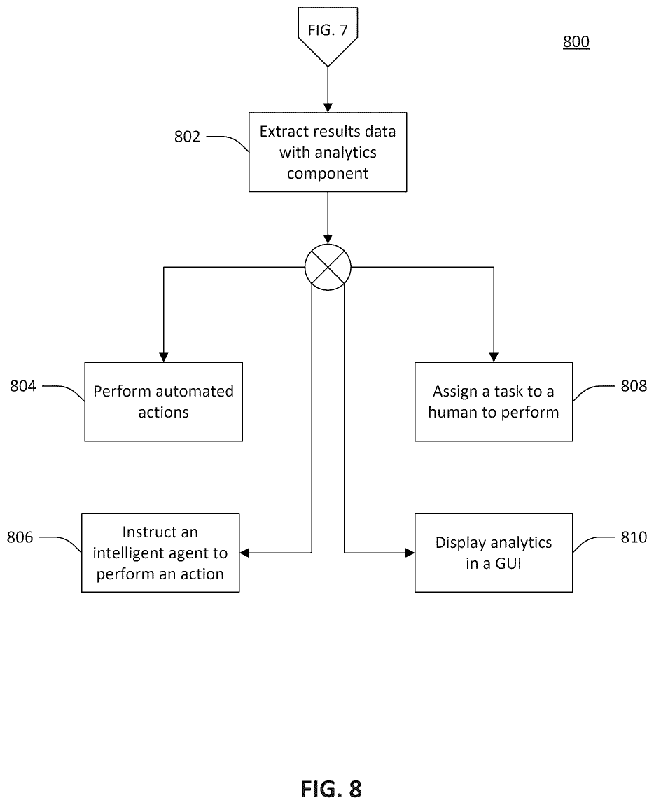

The ballot tally component 126 is configured to tally (e.g., count) all the submitted ballots when the snapshot is created. The ballot results ranking component 128 is configured to rank the tallied results in the snapshot. The metadata creation component 130 is configured to add metadata to the snapshot, such as a ballot identifier and additional information as described in connection with FIGS. 4 6. The hash calculation component 132 is configured to calculate a hash of all the data contained in the snapshot. The analytics component 134 is configured to perform various data analytics on the data contained in the snapshot. The post processing component 136 is configured to perform one or more actions based on the data contained in the snapshot, and as further described in connection with FIG. 8.

After the snapshot has been created, the snapshot 160 may be sent to snapshot storage 142 for short-term storage (for example, for use by the analytics component 134 and the post processing component 136) or for long-term storage.

FIG. 2 is a simplified block diagram illustrating an example user device 102, according to some embodiments of the present disclosure. In some embodiments, user device 102 may include a communication device having two-way or one-to-many data communication capabilities, audio communication capabilities, or video communication capabilities, and the capability to communicate with other computer systems, for example, via the Internet. Depending on the functionality provided by user device 102, in various embodiments, user device 102 may be a handheld device, a multiple-mode communication device configured for both data and voice communication, a smartphone, a mobile telephone, a laptop, a computer wired to a network, a netbook, a gaming console, a tablet, or a PDA enabled for wireless communication. In some embodiments, the user device 102 may be part of a network system including one or more networked devices.

User device 102 may include a case (not shown) housing components of user device 102. The internal components of user device 102 may, for example, be constructed on a printed circuit board (PCB). The description of user device 102 herein mentions a number of specific components and subsystems. Although these components and subsystems may be realized as discrete elements, the functions of the components and subsystems may also be realized by integrating, combining, or packaging one or more elements in any suitable fashion.

User device 102 may include a controller such as processor 110, which controls the overall operation of user device 102. Processor 110 may be one or more microprocessors, field programmable gate arrays (FPGAs), digital signal processors (DSPs), other types of data processing circuitry, or any combination thereof capable of executing particular sets of instructions. Processor 110 may interact with device subsystems such as transmitter 204 and receiver 206 for exchanging radio frequency signals with a wireless network (e.g., network 202) to perform communication functions.

Processor 110 may also interact with additional device subsystems including transmitter 204 and receiver 206, display 112, input devices 210 (e.g., a keyboard, a stylus, or control buttons), a persistent memory 212, a random access memory (RAM) 214, a read only memory (ROM) 216, auxiliary input/output (I/O) subsystems 218, a data port 220 (e.g., a conventional serial data port, a Universal Serial Bus (USB) data port, a 30-pin data port, a Lightning data port, or a High-Definition Multimedia Interface (HDMI) data port), a speaker 222, a microphone 224, camera 226, a short-range wireless communications subsystem 228 (which may employ any appropriate wireless (e.g., RF), optical, or other short range communications technology (for example, Bluetooth or NFC)), and other device subsystems generally designated as 230. Some of the subsystems shown in FIG. 2 perform communication-related functions, whereas other subsystems may provide “resident” or on-device functions.

Transmitter 204 and receiver 206 include one or more communication systems for communicating with network 202 to enable communication with any external devices (e.g., a server, not shown). The particular design of transmitter 204 and receiver 206 depends on the wireless network in which user device 102 is intended to operate. User device 102 may send and receive communication signals over the wireless network 202 after the required network registration or activation procedures have been completed.

In some embodiments, display 112 may be a touch-screen display. The touch-screen display may be constructed using a touch-sensitive input surface, which is coupled to an electronic controller and which overlays the visible element of display 112. The touch-sensitive overlay and the electronic controller provide a touch-sensitive input device and processor 110 interacts with the touch-sensitive overlay via the electronic controller.

Camera 226 may be a CMOS camera, a CCD camera, or any other type of camera capable of capturing and outputting compressed or uncompressed image data such as still images or video image data. In some embodiments, user device 102 may include more than one camera. Image data output from camera 226 may be stored in, for example, an image buffer, which may be a temporary buffer residing in RAM 214, or a permanent buffer residing in ROM 216 or persistent memory 212. The image buffer may be, for example, a first-in first-out (FIFO) buffer.

Short-range wireless communications subsystem 228 is an additional optional component that provides for communication between user device 102 and different systems or devices, which need not necessarily be similar devices. For example, short-range wireless communications subsystem 228 may include an infrared device and associated circuits and components, or a wireless bus protocol compliant communication device such as a Bluetooth® communication module to provide for communication with similarly enabled systems and devices.

Processor 110 may be one or more processors that operate under stored program control and executes software modules 232 stored in a tangibly-embodied non-transitory computer-readable storage medium such as persistent memory 212, which may be a register memory, a processor cache, a Random Access Memory (RAM), a flexible disk, a hard disk, a CD-ROM (compact disk-read only memory), a MO (magneto-optical), a DVD-ROM (digital versatile disk-read only memory), a DVD RAM (digital versatile disk-random access memory), or other semiconductor memories.

Software modules 232 may also be stored in a computer-readable storage medium such as ROM 216, or any appropriate persistent memory technology, including EEPROM, EAROM, FLASH. These computer-readable storage mediums store computer-readable instructions for execution by processor 110 to perform a variety of functions on user device 102. Alternatively, functions and methods may also be implemented in hardware components or combinations of hardware and software such as, for example, ASICs or special purpose computers.

Software modules 232 may include operating system (O/S) software 234, used to control operation of user device 102. Additionally, software modules 232 may include software applications 236 for providing additional functionality to user device 102. Software applications 236 may include a range of applications, including, for example, an e-mail messaging application, an address book, a notepad application, an Internet browser application, a voice communication (i.e., telephony or Voice over Internet Protocol (VoIP)) application, a mapping application, a media player application, etc. Each of software applications 236 may include layout information defining the placement of particular fields and graphic elements (for example, text fields, input fields, icons, etc.) in a user interface according to that corresponding application.

Operating system software 234 may provide a number of application protocol interfaces (APIs) providing an interface for communicating between the various subsystems and services of user device 102 and software applications 236. For example, operating system software 234 may provide a user interface API to any application that needs to create user interfaces for display on user device 102. Accessing the user interface API may provide the application with the functionality to create and manage screen windows and user interface controls, such as text boxes, buttons, and scrollbars; receive mouse and keyboard input; and other functionality intended for display on display 112.

In some embodiments, persistent memory 212 stores data 238, including data specific to a user of user device 102, such as information of user accounts. Persistent memory 212 may further store data relating to various applications with preferences of the particular user of, for example, user device 102. In some embodiments, persistent memory 212 may store data 238 linking a user's data with a particular field of data in an application, such as for automatically entering a user's name into a username textbox on an application executing on user device 102. Furthermore, in various embodiments, data 238 may also include service data including information required by user device 102 to establish and maintain communication with network 202.

In some embodiments, auxiliary input/output (I/O) subsystems 218 include an external communication link or interface, for example, an Ethernet connection. In some embodiments, auxiliary I/O subsystems 218 may further include one or more input devices, including a pointing or navigational tool such as a stylus, a clickable trackball or scroll wheel or thumbwheel, or a human finger; and one or more output devices, including a mechanical transducer such as a vibrator for providing vibratory notifications in response to various events on user device 102 (for example, receipt of a notification or a message or an incoming phone call), or for other purposes such as haptic feedback (touch feedback); or any combination thereof.

In some embodiments, user device 102 may also include one or more removable memory modules 240 (e.g., FLASH memory) and a memory interface 242. Removable memory module 240 may store information used to identify or authenticate a user or the user's account to a wireless network (e.g., network 202). For example, in conjunction with certain types of wireless networks, including GSM and successor networks, removable memory module 240 is referred to as a Subscriber Identity Module (SIM). Memory module 240 may be inserted in or coupled to memory module interface 242 of user device 102 to operate in conjunction with the wireless network 202.

User device 102 may also include a battery 244, which furnishes energy for operating user device 102. Battery 244 may be coupled to the electrical circuitry of user device 102 through a battery interface 246, which may manage such functions as charging battery 244 from an external power source (not shown) and the distribution of energy to various loads within or coupled to user device 102.

A set of applications that control basic device operations, including data and possibly voice communication applications, may be installed on user device 102 during or after manufacture. Additional applications or upgrades to operating system software 234 or software applications 236 may also be loaded onto user device 102 through the wireless network (for example network 202), auxiliary I/O subsystem 218, data port 220, short-range wireless communication subsystem 228, or another suitable subsystem such as 230. The downloaded programs or code modules may be permanently installed, for example, written into the persistent memory 212, or written into and executed from RAM 214 for execution by processor 110 at runtime.

User device 102 may provide three principal modes of communication: a data communication mode, a voice communication mode, and a video communication mode. In the data communication mode, a received data signal such as a text message, an e-mail message, Web page download, VoIP data, or an image file are processed by receiver 206 and input to processor 110 for further processing. For example, a downloaded Web page may be further processed by a browser application and output to display 112. A user of user device 102 may also compose data items, such as e-mail messages, for example, using the input devices, such as auxiliary I/O subsystem 218, in conjunction with display 112. These composed items may be transmitted through transmitter 204 over the wireless network (e.g., network 202). In the voice communication mode, user device 102 provides telephony functions and operates as a typical cellular phone. In the video communication mode, user device 102 provides video telephony functions and operates as a video teleconference terminal. In the video communication mode, user device 102 utilizes one or more cameras (such as camera 226) to capture video for the video teleconference.

FIG. 3 is a simplified block diagram of a server 300, according to some embodiments of the present disclosure. The server 300 shown in FIG. 3 may perform the functions of the server 104 shown in FIG. 1. In some embodiments, the server 300 may be part of a network system including one or more networked devices.

As shown in FIG. 3, server 300 may include processor 302. When processor 302 executes instructions described herein, server 300 may become a specialized machine for processing and continuous polling of networked users. Processor 302 may be any type of circuitry capable of manipulating or processing information. For example, processor 302 may include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 302 may also be a set of processors grouped as a single logical component. For example, as shown in FIG. 3, processor 302 may include multiple processors, including processor 302a, processor 302b, and processor 302n.

Server 300 may also include memory 304 configured to store data (e.g., a set of instructions, computer codes, intermediate data, or the like). For example, as shown in FIG. 3, the stored data may include program instructions and data for processing. Processor 302 may access the program instructions and data for processing (e.g., via bus 310), and execute the program instructions to perform an operation or manipulation on the data for processing. Memory 304 may include a high-speed random-access storage device or a non-volatile storage device. In some embodiments, memory 304 may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 304 may also be a group of memories (not shown in FIG. 3) grouped as a single logical component.

Bus 310 may be a communication device that transfers data between components inside server 300, such as an internal bus (e.g., a CPU-memory bus), an external bus (e.g., a universal serial bus port, a peripheral component interconnect express port), or the like.

For ease of explanation without causing ambiguity, processor 302 and other data processing circuits are collectively referred to as a “data processing circuit” in this disclosure. The data processing circuit may be implemented entirely as hardware, or as a combination of software, hardware, or firmware. In addition, the data processing circuit may be a single independent module or may be combined entirely or partially into any other component of server 300.

Server 300 may further include network interface 306 to provide wired or wireless communication with a network (e.g., the Internet, an intranet, a local area network, a mobile communications network, or the like). In some embodiments, network interface 306 may include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, server 300 may further include peripheral interface 308 to provide a connection to one or more peripheral devices. As shown in FIG. 3, the peripheral device may include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

In some embodiments, the server 300 may include a decentralized network of servers that together send data as a service to the user who requested the data.

FIG. 4 is an example ballot 400, according to some embodiments of the present disclosure. The ballot 400 may include a voter name label 402. For example, the voter name label 402 may include a user's name. In some embodiments, the voter name label 402 may be optional because, as noted elsewhere in this disclosure, the voter's eligibility to vote is based on token ownership and not the voter's name. In some embodiments, the voter may decide whether to include the voter name label 402 in the ballot 400. The ballot 400 also includes a voter identifier 404. For example, the voter identifier 404 may include a numeric code or an alphanumeric code to uniquely identify each voter. In some embodiments, the voter identifier 404 may change for each poll conducted. For example, a different voter identifier 404 may be provided to the same voter for each poll for privacy reasons, such as to make it difficult to identify any individual voter.

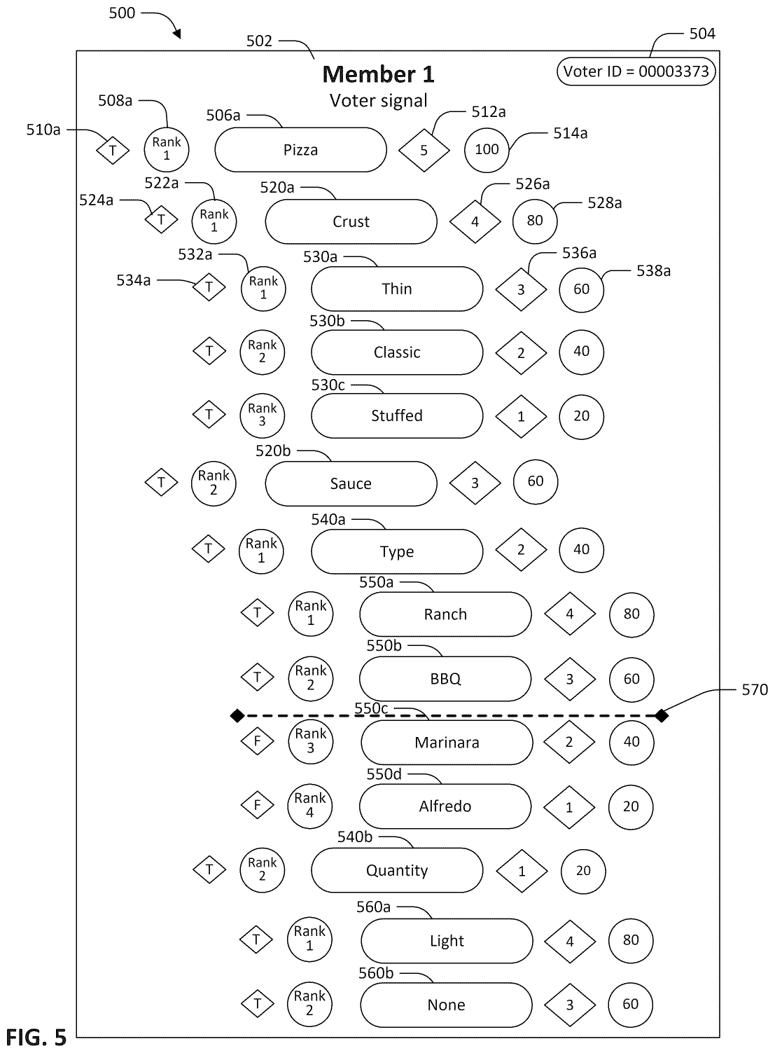

The ballot 400 includes a number of options 406a, 406b, 406c, 406d, and 406e and based on the construction of the ballot, the voter may be able to select one or more options. In some embodiments, the ballot 400 may implement ranked choice voting, in which the voter may select one or more options and rank the selected options in a preferred order. For example, the ordering may include first choice, second choice, third choice, etc. The ballot 400 shown in FIG. 4 includes a single layer of options. As will be discussed in connection with FIG. 5, the ballot may be constructed to include multiple layers of options. For example, categories and sub-categories.

The ballot 400 includes an example in which ranked choice voting is implemented. A numerical indicator 408 is displayed to show the rank assigned to that choice by the voter. In some embodiments, different graphical user interface (GUI) elements may be implemented to enable the voter to rank their choices. For example, the numerical indicator 408 may be configured to enable to voter to type a number corresponding to the value that the voter wishes to assign to the option (e.g., “1,” “2,” “3,” etc.). As another example, the GUI may be configured to enable the voter to drag and drop either the option 406 or the numerical indicator 408 to the desired position and the other fields associated with the particular choice will be repositioned and numerical values (e.g., rank) adjusted to correspond to the current rank position of the option 406.

A Boolean indicator 410 may be displayed to indicate whether the user has ranked the choice. For example, the poll owner may assign a default ordering for the options 406 or the options 406 may be randomly ordered when the voter accesses the ballot. The Boolean indicator 410 will display an “F” or other negative indication to show that the voter has not ranked the corresponding choice. For example, Boolean indicator 410e (showing an “F”) indicates that the voter has not ranked option 406e (“popcorn”). As another example, Boolean indicator 410b (showing a “T”) indicates that the voter has ranked option 406b (“ice cream”). It is noted that other types of Boolean indicators are possible, such as using a “1” for a “true” value and a “0” for a “false” value or displayed as different UI elements in a GUI.

The ballot 400 includes a rank weight value 412. For example, the rank weight value 412 may be a number of points that the voter has assigned to the corresponding option 406. For example, the voter may assign a value of “5” to the rank weight value 412a for option 406a (“pizza”). In some embodiments, the rank weight value 412 may be automatically assigned to the numerical indicator 408 and may be an inverse of the number of options in the ballot or the number of options ranked by the voter. For example, if there are five options, then the rank weight value 412 for the first choice (e.g., the option 406 given the highest ranking by the voter) may be assigned five points. As another example, if there are ten options and the voter has only ranked five of the ten options, then the highest ranked option may have ten points, the second highest ranked option may have nine points, etc. and the five unranked options may have zero points. In other embodiments, other point allocation systems may be used.

In some embodiments, the points assigned to the unranked options may be evenly divided among the unranked options. For example, a poll may have six options (e.g., voting on a color preference between orange, red, blue, yellow, black, and white). The voter ranks their top three options (e.g., orange, red, and blue) and leaves three options unranked (yellow, black, and white). Because there are six options in the poll, the voter's first choice may be assigned six points, the second choice assigned five points, etc. By only ranking three options, there are six total unassigned points (e.g., 3+2+1=6) for the unranked options. These six points may be divided equally among the unranked options, such that in the final poll prior to submission, orange has 6 points, red has 5 points, blue has 4 points, and yellow, black, and white have 2 points each. This points distribution may be similarly applied to polls with different numbers of options. The total of the unused points is divided by the number of unranked options to determine the number of points to assign to each unranked option. This points distribution mechanism may result in some unranked choices having a non-round number of points (e.g., 1.5 points per unranked option in a poll with six options and two unranked options).

In some embodiments, the unranked options may be randomly assigned a number of points. Continuing the above example, under a random points assignment, black may have 3 points, yellow may have 2 points, and white may have 1 point.

It is noted that other ways of assigning the rank weight value 412 to the corresponding option 406 are possible and are contemplated within the scope of the present disclosure.

The ballot 400 includes a points total 414, which may be determined by multiplying a number of votes assigned to the voter by the number of points defined by the rank weight value 412. In some embodiments, each voter may have a different number of votes assigned to them. For example, in a token-based system, the voter may have a number of votes corresponding to a number of tokens held by the voter. As shown in FIG. 4, the voter has 30 votes, as indicated by metadata item 426. For example, the voter assigned option 406c (“candy bar”) a rank weight value 412c of three points, giving a points total 414c of 90 points (e.g., three points×30 votes) for option 406c. In some embodiments, in which the user is verified based on their electronic mail address or other identification means, the number of votes for the user may be stored in a database.

The ballot 400 includes a “submit ballot” button 416. In some embodiments, the button 416 may have a different text label and allows the voter to submit their ranked ballot. After the voter has completed the ballot (e.g., ranked all the choices that the voter wishes to rank), the voter may activate the submit ballot button 416. In some embodiments, another GUI element other than a button may be provided such that the voter may interact with the GUI element to indicate that the ballot should be submitted at the desired time. In some embodiments, voting may be open for a predetermined period of time such that the voter may update their choices and resubmit the updated choices as long as the poll is open. In some embodiments, the poll may remain open indefinitely and the snapshots are periodically taken to present results at the point in time corresponding to the snapshot. In some embodiments, snapshots may be taken at intervals. For example, snapshots may be taken hourly, daily, or every seven days. It is noted that other time intervals (either fixed periods of time or non-fixed periods of time) for taking snapshots are possible and are within the scope of the present disclosure. In some embodiments, snapshots may be taken randomly.

Various metadata elements 420 may be associated with the ballot 400. A ballot identifier 422 is associated with each ballot and is generated when the ballot is created. For example, the ballot identifier 422 may be a numeric identifier or an alphanumeric identifier. A poll version number 424 indicates a current version number of the poll. In some embodiments, the poll version number 424 may change every time the poll owner makes changes to the poll.

A number of votes indicator 426 indicates the number of votes assigned to the voter. As noted above, in some embodiments, the number of votes assigned to the voter may correspond to a number of tokens held by the voter. In other embodiments, other mechanisms for assigning different numbers of votes to each voter may be implemented and be within the scope of the present disclosure. In some embodiments, the number of votes held by the voter may change while a poll is open and after the voter has submitted their ballot. For example, in a token-based system, the voter may acquire more tokens or may release some tokens (e.g., sell or give away tokens) such that the number of votes associated with the voter changes. If the number of tokens associated with the voter changes while the poll is still open, the points total 414 for each option 406 will be automatically updated at a time associated with the next snapshot (described below) to reflect the current number of votes. For example, if instead of having 30 tokens, the voter acquires an additional 20 tokens (for a total of 50 tokens), the voter's points totals 414 for each of the options 406 will be automatically updated to reflect the now-held 50 tokens. It is noted that the voter may also change their votes while the poll is still open and the new points totals 414 would reflect both the changed votes and the new number of tokens.

As another example, in a certificate-based system, a user can create a group and invite other users, email addresses, or blockchain-based accounts to the group. The creator or manager of the group may then add, remove, or modify the number of votes each user in the group would get. The group manager may also set the number of votes that each certificate is worth and could set one or more certificates as being eligible to vote. In some embodiments, this certificate-based system may function like an off-blockchain token, stored in either a database (e.g., a web2-type database) or other storage method. It is noted that the embodiments described herein operate in a similar manner, whether a token-based system or a certificate-based system is used to determine voter identity, a voter's eligibility to vote in certain polls, the number of votes held by a voter, or other parameters.

After the voter submits their ballot (for example, by activating the submit ballot button 416), a voter signature 428 is generated. For example, the voter signature 428 may be used to provide verification that the voter has “signed” their ballot by submitting it. The voter signature 428 may be based, at least in part, on a timestamp when the ballot was submitted. In some embodiments, the voter signature 428 may be based on a cryptographic function on a public/private key pair. A voter signal identifier 430 may be used to identify the particular ballot submitted by the voter at a particular timestamp. The term “voter signal” may be used to refer to an active ballot of a voter. For example, if the voter later changes their votes while the poll is still open, then the voter signal identifier 430 will be different for the newly submitted ballot. As used herein, the term “voter ballot” (or “ballot”) refers to a voter's ranked options. The term “voter signal” is the voter ballot plus the number of votes and ranked options points computations. A timestamp of submission 432 is the timestamp of when the voter submitted the ballot.

For example, if the voter later changes their votes while the poll is still open, then the timestamp of submission 432 will be different for the newly submitted ballot.

A snapshot identifier 434 is an identifier of a particular snapshot that the submitted ballot is associated with. In some embodiments, the ballot results are tallied on a periodic basis, which may be set by the poll's owner. For example, the ballot results may be tallied on an hourly, daily, weekly, or other time period basis. When the ballot results are tallied, this is a “snapshot” of the current status of all active ballots at the time that the snapshot is taken. As used herein, the term “active ballot” refers to the most recently submitted ballot by a voter. For example, if a voter submitted a ballot one week ago and submitted a new ballot one day ago, the active ballot is the new ballot submitted one day ago. A voter may only have one active ballot at a given point in time. Any earlier submitted ballots (such as the ballot submitted one week ago) would be considered inactive ballots. In some embodiments, the snapshot identifier 434 may not be displayed as part of the ballot 400 until the voter has submitted the ballot. For example, if the voter is in the process of voting and has not yet submitted the ballot, the votes have not yet been counted and there is no corresponding snapshot associated with the ballot. As noted above, once the voter submits the ballot, those votes will be included in the next periodic snapshot.

A hash 436 of all the fields in the ballot 400 is calculated. The hash 436 is calculated the first time that the voter submits the ballot. If the voter resubmits the ballot with changes at a later time, then the hash 436 would be recalculated based on the ballot changes.

At a later time (for example, at a time of a later snapshot), if the voter has not made any change to their ballot from the previous submitted ballot, all the data in the ballot stays the same and the voter signal identifier 430 will stay the same. In some embodiments, the voter signal may be remade with a new voter signal identifier 430 if a new signed ballot is submitted by the voter (e.g., an action is taken by the voter) or if the number of votes held by the voter has changed since the time of the preceding snapshot. For example, the number of votes held by the voter may change if the voter's account has more voting tokens or fewer voting tokens, there is an updated voting object where voting rules associated with the poll have changed (e.g., the number of votes assigned to a single token has changed or the token types eligible to vote in the poll have changed, which causes a change in the number of votes that the voter has), or the voting decay rules apply to change the number of votes that the voter has. In such circumstances, this is a new voter signal created from the same ballot but with a new number of votes.

If the voter has not changed any of their votes, the timestamp 432 will stay the same because the timestamp relates to the time when the ballot was submitted. In some embodiments, at the time the snapshot is taken, the previously submitted ballots may be examined to determine whether the voter has submitted a new ballot (e.g., whether the rankings for any of the options has been changed) and to determine whether a number of votes associated with the voter has changed since the last time the ballot was submitted (e.g., whether the voter has more votes or fewer votes than the prior time). If nothing has changed on the ballot from the prior submission, then computing resources may be saved by not recomputing the hash for the data in the ballot 400 because nothing has changed and the hash 436 would be the same. In some embodiments, the submitted ballot may include an indicator (e.g., a flag) indicating that the submitted ballot is an active ballot. If the voter then submits a new ballot (e.g., refreshes their ballot), then the previously submitted ballot may have its indictor changed to “inactive” or similar indicator to indicate that the previously submitted ballot is no longer active and should not be included in any subsequent tallies or snapshots.

At the later time, if the voter has changed any of their votes (e.g., re-ranked any previously ranked option or ranked a previously unranked option) then the ballot data will be updated either when the voter submits the new ballot with the changed or new vote. Alternatively, if at the later time, the number of votes assigned to the voter has changed (e.g., the voter acquires additional tokens, has fewer tokens, acquires additional certificates, or has fewer certificates), the voter does not need to take any action to have the new vote totals counted. If the voter makes any changes to the ballot (in addition to the change in the number of votes), then the voter would need to submit a new ballot. In some embodiments, the voter may choose to submit a new ballot to “refresh” the voting decay on their ballot. For example, voting decay rules may apply to the poll, such that the voter's number of votes automatically decreases after a predetermined number of days. To avoid the voting decay from being applied, the voter may “refresh” their ballot by submitting a new ballot with the same rankings as the previous ballot. To refresh their ballot, the voter does not need to make any changes to the ballot; the voter may submit the same ranked options at a later point in time. In such circumstances, the most recently submitted ballot would be the active ballot for that voter. The ballot may be considered to be a new ballot even if the rankings are the same as the prior ballot because the timestamp associated with the ballot signature is different.

In some embodiments, “voting decay” may be applied to decrease a voter's voting power over time if the voter does not refresh their ballot within a predetermined period of time. For example, voting decay rules may be included in the voting object associated with a particular poll. If the voter has not refreshed their ballot within the predetermined period of time (e.g., 400 days or other period of time), then the voting token weight for each vote of the voter may be reduced (e.g., by 50% or other value). The decayed votes may then be automatically resubmitted, re-tallied, and incorporated into the next snapshot following application of the voting decay rules. This process may be performed automatically because the voter has not taken any action with respect to the ballot for the predetermined period of time. For example, the number of eligible votes (e.g., as determined by the number of tokens or certificates of the voter) is multiplied by the number of votes per token and applying the voting decay rules to determine the correct number of votes that a voter should have. The number of votes is multiplied by each rank weight to obtain the option points for each option. The voter signal may then be constructed based on these calculations.

In some embodiments, after a poll has been created, the poll owner may make changes to the poll, including after some ballots have already been submitted and before or after snapshots have been generated. For example, the poll owner may remove an option (e.g., option 406e) from the ballot or may change an option on the ballot (e.g., change option 406e from “popcorn” to “pretzels”). In either of these circumstances, the poll version number 424 would change. If an option is changed in a poll, the changed option automatically would be presented as an unranked option; all other unchanged options would retain their original ranking. In some embodiments, when a poll is changed by the poll owner, all voters who previously submitted ballots may be notified of the change and that the changed options are now unranked. In some embodiments, new tallied ballots may be generated from all active ballots with the new option or changed option being marked unranked.

FIG. 5 is an example of a multi-layer ballot 500, according to some embodiments of the present disclosure. In some embodiments, the ballot may be constructed with multiple layers such that the voter may select multiple options for multiple different, but related, choices. The multi-layer ballot may also be referred to as a “multi-dimensional consensus tree.” The example ballot 500 shown in FIG. 5 uses options for ordering food as an example. As discussed elsewhere in this disclosure, in some embodiments, the token or certificate related to the user's account may be used to control whether the user is eligible to vote on certain options in the poll. In connection with the multi-layer ballot, in some embodiments, if the user is not eligible for vote for a parent option, the user would also not be eligible to vote for child options under the parent option. In other embodiments, the control over the voting eligible options may be more granular such that access to vote on individual child options may be controlled by the user's token or certificate.

The ballot 500 may include a voter name label 502, similar to the voter name label 402 described in connection with FIG. 4. The ballot 500 also includes a voter identifier 504, similar to the voter identifier 404 described in connection with FIG. 4.

The ballot 500 includes a number of options at different levels. As shown in FIG. 5, a top-level option 506a includes “pizza.” It is noted that other top-level options may be provided in the ballot 500, but for purposes of illustration, only one top-level option 506a is shown. In connection with option 506a (“pizza”), the voter has assigned numerical indicator 508a a value of “1” for a highest ranked option at this level and Boolean indicator 510a shows that the voter has ranked this option (shown by the “T”). The voter has assigned a rank weight value 512a of five points to this option. The voter has 20 votes (not shown in FIG. 5), to determine a points total 514a of 100 points (e.g., five points × 20 votes) for option 506a.

Two second-level options 520 are provided (“crust,” option 520a and “sauce,” option 520b). The hierarchical structure of the ballot 500 may be carried to multiple levels and may be constructed in any manner by the poll owner to organize the different levels. For example, under second-level option 520a (“crust”), three third-level options 530 may be provided (“thin,” option 530a; “classic,” option 530b; and “stuffed,” option 530c). As another example, under second-level option 520b (“sauce”), two third level-options 540 may be provided (“type,” option 540a and “quantity,” option 540b). Additional levels of options may be provided, depending on the nature of the choices to be made. As shown in FIG. 5, the third-level option 540a (“type”) may include four fourth-level options 550 (“ranch,” option 550a; “BBQ,” option 550b; “marinara,” option 550c; and “alfredo,” option 550d). Similarly, the third-level option 540b (“quantity”) may include two fourth-level options 560 (“light,” option 560a and “none,” option 560b). It is noted that the number of options at a given level of the hierarchy is not limited and the ballot 500 may be constructed with any number of options at each level.

Line 570 is a visual indication that the options located above the line 570 (e.g., options 550a, 550b) are ranked while options located below the line 570 (e.g., options 550c, 550d) are unranked. As such, the position of the line 570 may vary. For example, if the voter ranks option 550c, the line 570 would move to be located between options 550c and 550d. In some embodiments, the line 570 is optional and may not be displayed.

Similar to the description of FIG. 4, each of the options shown in FIG. 5 may be separately voted on by the voter. For example, in connection with option 520a (“crust”), the voter has assigned numerical indicator 522a a value of “1” for a highest ranked option at this level and Boolean indicator 524a shows that the voter has ranked this option (shown by the “T”). The voter has assigned a rank weight value 526a of four points to this option. The voter has 20 votes (not shown in FIG. 5), to determine a points total 528a of 80 points (e.g., four points×20 votes) for option 520a.

As another example, in connection with option 530a (“thin”), the voter has assigned numerical indicator 532a a value of “1” for a highest ranked option at this level and Boolean indicator 534a shows that the voter has ranked this option (shown by the “T”). The voter has assigned a rank weight value 536a of three points to this option. The voter has 20 votes (not shown in FIG. 5), to determine a points total 538a of 60 points (e.g., three points×20 votes) for option 530a.

In some embodiments, the voter may rank “child” options but not the corresponding “parent” option. For example, the voter may not provide a rank for option 540a (“type”) but may provide rankings for the corresponding “child” options (e.g., options 550a-550d).

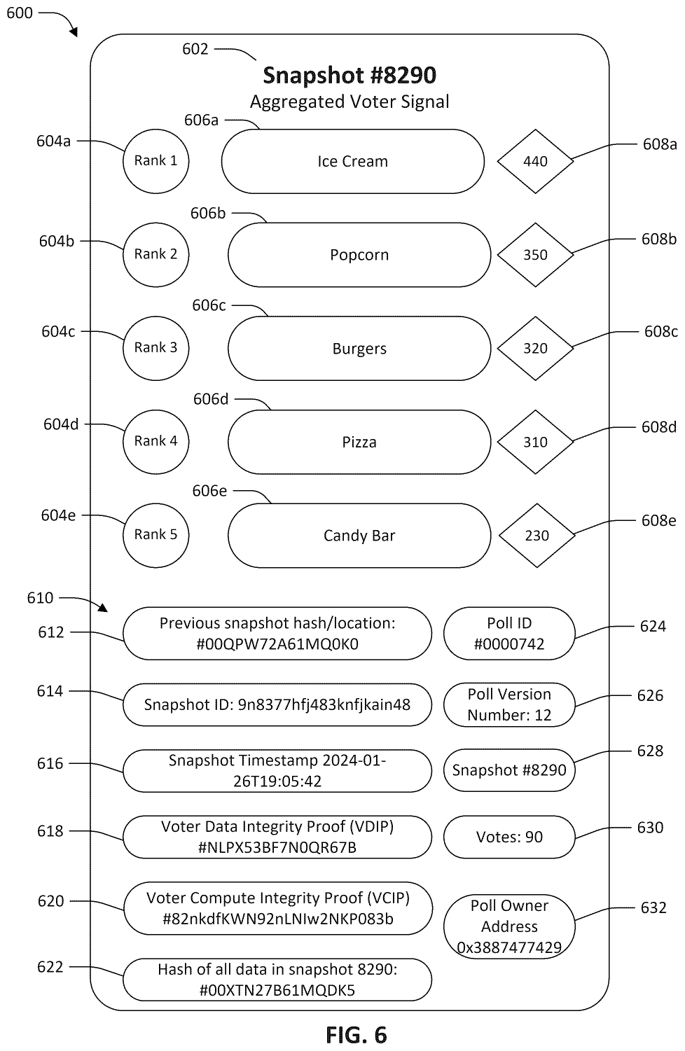

FIG. 6 is an example of an aggregated ballot 600, according to some embodiments of the present disclosure. The term “aggregated ballot” may be used to refer to all the voter signals aggregated together and may also be referred to as an aggregated voter signal. The aggregated ballot 600 includes a snapshot identifier 602, which may include a sequential numerical identifier, such as the value “8290” shown in FIG. 6. It is noted that any type of identifier may be used to identify different snapshots of the same poll. A snapshot is taken at periodic intervals, with the intervals being determined by the poll owner. For example, the intervals may be hourly, daily, weekly, or other predetermined period of time. When the snapshot is taken, all submitted ballots are tallied. For example, if a voter is in the process of voting and has not submitted their ballot when the snapshot is taken, that voter's ballot will not be included in the snapshot, but would be included in the following snapshot if the ballot is submitted in the time period between snapshots. In some embodiments, a poll may remain open for a predetermined period of time and snapshots may be periodically taken to enable results to be viewed. For example, if the poll is public, anyone may view the results. As another example, if the poll is private, the poll owner and any eligible voter may view the results.

For each option of the ballot, different tallied information may be displayed. A cumulative rank indicator 604 may be displayed to indicate the rank for each option 606, along with a cumulative points total 608. For example, the option 606a (“ice cream”) may have a cumulative rank 604a of “1” and a cumulative points total 608a of 440 points. While FIG. 6 shows five options 606a-606e, it is noted that any number of options 606 may be displayed and the results of a multi-level ballot (similar to that shown in FIG. 5) may also be displayed in a similar manner. In some embodiments, if two or more options have the same cumulative points total, then the tied options may be randomly ranked.

The aggregated ballot 600 may also include several metadata elements 610. A location of where the immediately preceding snapshot 612 is stored may be included. For example, a hash of snapshot number 8289 may be linked to in the aggregated ballot 600. In some embodiments, linking to hashes of the preceding ballot may be used to help prove the validity or integrity of the poll. For example, the location 612 may include a pointer to the immediately preceding snapshot, such as to a prior block in a blockchain. In some embodiments, the snapshot number may be used to help track back through other snapshots of the same poll, with the snapshot hash 612 acting as a unique identifier of that individual snapshot. For example, this may be used to associate this particular snapshot number 8289 with poll identifier 0000742, since other polls may also have a snapshot number 8289.

A snapshot identifier 614 may be a numeric or alphanumeric identifier of the snapshot. A snapshot timestamp 616 may be a time at which the snapshot was taken. A voter data integrity proof (VDIP) 618 may be used to prove completeness and validity of the aggregated ballot 600. For example, the VDIP 618 may be used to prove that all the data in the aggregated ballot 600 is the correct and verified data and that each voter's ballot is included in the aggregated ballot 600. With the VDIP 618, each voter can independently verify that their vote was included in the aggregate ballot 600 without needing to access any other voter's vote. In some embodiments, the VDIP 618 may be implemented by using a Verkle proof, a Merkle proof, other type of integrity proof, or other type of proving mechanism. In some embodiments, a voter may scan a code (e.g., a QR code) or access a link (e.g., a hyperlink) to receive cryptographic proof that their vote exists unaltered in the aggregate ballot 600. In some embodiments, if the VDIP 618 is not present in the aggregated ballot 600, a flag (e.g., a visual indicator) may be attached to the aggregated ballot 600 or displayed with the aggregated ballot 600 to indicate the VDIP 618 is not present.

A voter compute integrity proof (VCIP) 620 may be used to verify that all calculations made to obtain the end result were correctly calculated. In some embodiments, the VCIP 620 may be implemented by using a zero knowledge proof to prove the compute result was not fraudulent. For example, a zero knowledge proof may be selected such that it does not require interaction between the prover and the verifier. For example, a zkSNARK, a zkSTARK, a multi-party compute mechanism, or other type of proving mechanism or primitive may be used to prove that the compute results on a server were conducted accurately and completely in accordance with the expected result without any kind of fraud. In some embodiments, other mechanisms to verify the integrity of the computation that creates the result may be used. For example, a trusted execution environment (TEE) or a multi-party compute network may be used. Such mechanisms may allow the verifier (e.g., a voter or an observer) to prove that the results are able to be verified without needing to trust the server that the results were computed on. In some embodiments, the aggregated ballot 600 may include one or more of: a validity proof of the data in the aggregated ballot, an anti-fraud proof of the data in the aggregated ballot, and a completeness proof of the data in the aggregated ballot.

A hash 622 of all the data in the snapshot is provided. For example, the hash 620 may be based on all data in the snapshot, including the metadata elements 610. A poll identifier 624 is included in the aggregated ballot 600; the poll identifier 624 will match the corresponding ballot identifier in the individual ballots completed by the voters. A poll version 626 is included in the aggregated ballot 600; the poll version 626 will match the corresponding poll version in the individual ballots completed by the voters. A snapshot identifier 628 is included in the aggregated ballot 600; this is the same as the snapshot identifier 602 displayed at the top of FIG.

6. A total number of votes cast 630 is included in the aggregated ballot 600 and is a sum of the active votes across all active voter signals that are submitted prior to the snapshot timestamp 616. A poll owner identifier 632 is included in the aggregated ballot 600 and is an identifier of the poll's owner. In some embodiments, the poll owner identifier 632 is a numeric identifier, an alphanumeric identifier, an email address, a hyperlink, or another address type that may be used to uniquely identify the poll owner.

In some embodiments, variations of the ballot and the aggregated ballot may be implemented. It is noted that some variations may be optional and may be selectable by the poll owner. In some embodiments, the number of votes assigned to a voter may automatically decay after a predetermined period of time. For example, the number of votes assigned to a voter may be halved every 400 days. As another example, the decay amount and the length of time before the decay is effective may vary and, in some embodiments, may be determined by the poll owner. For example, the voting decay rules (including the decay amount) may be specified in the voting object, as described elsewhere in this disclosure. In some embodiments, a poll may be closed. The existing ballot results (e.g., snapshots) would still be stored, but no new snapshots would be generated. In some embodiments, a paused poll may be reopened at a later point in time and the cumulative data would still be retained in the snapshots. In some embodiments, the cumulative data may be retained as long as a permanent storage network where the snapshots are stored continues hosting the files and stays operational.

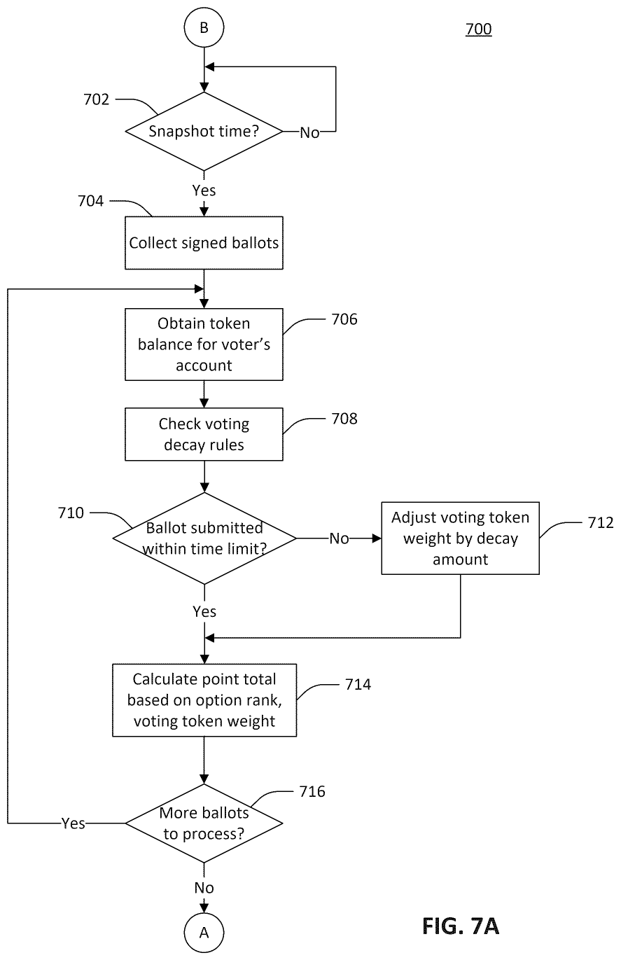

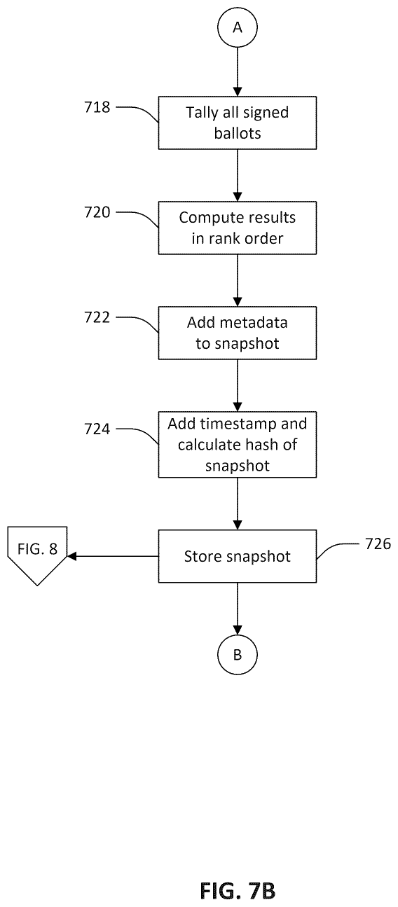

FIGS. 7A and 7B are a flowchart of an exemplary method 700 for creating a ballot snapshot, according to some embodiments of the present disclosure. The method 700 may be performed by server 104, server 300, or other computing device.

A determination is made whether a current time is a snapshot time (step 702). Snapshots may be periodically taken and the time period may be determined when the poll is created. For example, snapshots may be taken hourly, daily, weekly, monthly, or at some other predetermined time interval.

All active ballots are collected (step 704). For example, only one active ballot may be collected from each voter. Any inactive or incomplete ballots may be ignored. For each ballot to be included in the snapshot, a determination is made whether the ballot has been signed by the voter and is the active ballot for the voter. If the ballot has not been signed by the voter or is an inactive ballot, then the ballot from that voter is not included in the current snapshot. In some embodiments, because a poll may be “open” for an extended period of time, the voter may change their votes, as described elsewhere in this disclosure. Each time that a voter submits a ballot, the prior submitted ballots are marked as “invalid” or “inactive,” for example, such that only the most recently submitted ballot is counted in the snapshot.

For each signed ballot, the following operations are performed. A token or certificate balance for the voter's account is obtained (step 706). As used herein, the term “token balance” refers to a number of tokens associated with a voter's account. As described elsewhere in this disclosure, a voter's token balance may change over time while a given poll is open. As described elsewhere in this disclosure, in some embodiments, each poll may have an associated voting object that includes information such as the rules for which voters are eligible to vote on the poll (e.g., which tokens need to be held by a voter to prove eligibility), how the votes for the active ballots will be calculated (e.g., a number of votes per eligible token type), and voting decay rules. The voting decay rules for the voter are checked (step 708). For example, the voting decay rules may be checked by accessing the voting object associated with the submitted ballot.

A determination is made whether the voter has submitted the ballot within the time limit prescribed by the voting decay rules (step 710). If the voter has not submitted the ballot within the time limit (step 710, “no” branch), then the voting token weight is adjusted by the decay amount specified in the voting decay rules (step 712). In some embodiments, the voting decay may be repeatedly applied, up to a predetermined limit. For example, the voting decay may be set such that the number of votes is halved every 400 days and a decay cycle limit may be set to five cycles. After every 400 days has passed and the voter has not refreshed their ballot (e.g., submitted a new ballot as described elsewhere in this disclosure), then number of votes for that voter is halved. After five cycles of voter decay have been completed without the voter refreshing their ballot, the active voter signal from that voter may be considered to have expired and the “inactive” state of the ballot may be turned off. If the voter later wishes to refresh their ballot, the voter would need to log into the system to submit a new ballot. In some embodiments, the prior option rankings may be retained.

If the voter has submitted the ballot within the time limit (step 710, “yes” branch) or after the voting token weight has been adjusted (step 712), the point total for each option in the ballot is calculated based on the option rank value and the voting token weight (step 714).

A determination is made whether there are more ballots to process (step 716). If there are more ballots to process (step 716, “yes” branch), then the method 700 returns to step 706 to obtain the token balance for the next ballot. If there are no more ballots to process (step 716, “no” branch), then the method 700 proceeds to step 718 to tally all the active signed ballots.

All the active signed ballots are tallied (step 718). The tally may include a summation across all active ballots and the point totals for each option in the ballot, as calculated in step 714. For example, as shown in FIG. 6, for option 606a (“ice cream”), the points total 608a is 440 points. The results of the tallied submitted voter signals are computed to determine a rank order of each option in the aggregated ballot to be included in the snapshot (step 720). For example, as shown in FIG. 6, the snapshot 600 shows the rank indicators 604 of each option 606 based on the corresponding points total 608, ranked from most points (rank 1) to fewest points (rank 5). Metadata for the snapshot is added to the snapshot (step 722). For example, as shown in FIG. 6, metadata 610 may include items such as previous snapshot location 612, snapshot identifier 614, poll identifier 624, poll version number 626, snapshot number 628, total number of votes cast 630, and poll owner identifier 632. A timestamp corresponding to a time of the snapshot is added to the snapshot and a hash of the data in the snapshot is calculated (step 724). For example, as shown in FIG. 6, the snapshot timestamp 616, the hash 622 of all data in the snapshot, the voter data integrity proof 618, and the voter compute integrity proof 620 may be added to the snapshot.

The snapshot is then stored (step 726). In some embodiments, the snapshot may be stored to a permanent storage, for example, a blockchain, a blockweave, or distributed storage format. Such storage may be used to provide immutable data integrity (e.g., an immutable digital copy) for the snapshot and may be useful for decentralized storage of information. In some embodiments, the permanent storage may be used as a backup to restore data in the event of a storage system failure. In some embodiments, the snapshot may be stored to a conventional database for fast access and output to analytics functions. In some embodiments, the snapshot may be stored to both the permanent storage and the database.

In some embodiments, the snapshot may be stored in the form of a zero knowledge proof, for example on a zero knowledge virtual machine (ZKVM) or on a zero knowledge blockchain. In some embodiments, the snapshot may be queried to provide some information about the snapshot while keeping other information about the snapshot private. For example, a snapshot may be queried “is the option ‘white’ ranked within the top five?” and a result of true or false (or similar indicator) may be returned without disclosing additional information about the snapshot.

After the snapshot is stored, additional processing of the snapshot and the data contained in the snapshot may be further processed, as described in connection with FIG. 8. After the snapshot is stored, then the method 700 returns to step 702 to wait for the next snapshot time.

FIG. 8 is a flowchart of an exemplary method 800 for aggregated ballot processing, according to some embodiments of the present disclosure. The method 800 may be performed by server 104, server 300, or other computing device. In some embodiments, the method 800 may be performed after a snapshot has been created and stored, as described in connection with FIG. 7. In other embodiments, the method 800 may be performed at any time, as long as at least one snapshot is available.

A snapshot may be processed by an analytics component to extract the results data from the snapshot (step 802). In some embodiments, the snapshot contains the aggregated points totals for all options from the start of the poll to present. In some embodiments, the snapshot contains a difference in the points totals between a time of the previous snapshot to a time of the current snapshot. In some embodiments, the snapshot contains all data from all snapshots of the poll. In some embodiments, snapshot data may be processed based on the most recent snapshot; a series of snapshots from a first time to a second time, wherein all the snapshots between the first time and the second time are tallied and a time averaged snapshot is generated; or a “delta snapshot,” comparing snapshots from two different times (e.g., the most recent snapshot and the preceding snapshot). For example, the delta snapshot may represent changing sentiment and may include actual results (e.g., may not include current point totals for each option, but may include the change in point totals between the two snapshots). It is noted that other ways of processing the snapshot are possible and are within the scope of the present disclosure.

In some embodiments, the analytics component may be configured to perform additional types of processing on submitted ballot data. For example, a poll may be configured to enable multiple different voting token or certificate types to be eligible to vote in the poll. As an example, if there is a state-wide poll, tokens may be held by residents of different cities in the state and any city token holder may be eligible to vote in the state-wide poll. The poll results may then be tallied at the city level (using the individual city tokens) and at the state level (using all the city tokens in the state). Similarly, the same city token may enable the city token holder's ballot to include both city-specific options and the state-wide options, such that the city token holder may vote on both sets of options in the same ballot. In other embodiments, the city-specific options and the state-wide options may be on separate ballots.

In such embodiments, the tokens may be hierarchically structured and assigned at the lowest level of the hierarchy. For example, a hierarchy may be structured as: city district (lowest level), city-wide (next level higher), and state (highest level). Tokens may be assigned to voters at the city district level. When the ballots are tallied, the analytics component may apply filters based on the tokens to provide different levels of aggregated ballots. For example, the filter may include only the city district tokens to provide results by city district. A second filter may be at the city level and would include all city district tokens within the city. A third filter may be at the state level and would include all city-wide and city district tokens in the state. It is noted that the number of levels of the hierarchy can vary, and that each level higher in the hierarchy may group the lower level tokens in various combinations.

In some embodiments, a voter may own several different types of tokens and may configure preferences (e.g., via a user interface such as a graphical user interface) to enable the voter to see polls only for some of those tokens. For example, the voter may create a filter based on one or more selected token types and only see polls that the selected token types can vote in.

After the analytics component has extracted the results from the ballot, one or more additional steps 804, 806, 808, 810 may be performed (as represented by the flow control element shown in FIG. 8). It is noted that not all steps 804, 806, 808, 810 need to be performed and that steps 804, 806, 808, 810 may be performed serially or in parallel.

The extracted results may be used to perform automated actions (step 804). In some embodiments, the aggregated ballot data may trigger automatic actions to be performed. For example, when used in connection with a decentralized autonomous organization, the aggregated ballot data may be used to automatically perform actions on a blockchain or off the blockchain if certain conditions are met, such as a predetermined number of points for an option in the poll (e.g., similar in operation to a smart contract that is automatically executed based on certain conditions being met). It is noted that other conditions than the predetermined number of points may be used to trigger actions to be performed.

The extracted results may be used to instruct an intelligent agent to perform an action (step 806). For example, one or more intelligent agents may use the aggregated ballot results as inputs for one or more commands for execution.

The extracted results may be used to assign a task to a human to perform (step 808). For example, the aggregated ballot data may indicate to a human that a particular task is to be performed based on the ballot results. In some embodiments, a single task may be divided into sub-tasks and some sub-tasks assigned to a human to perform and other sub-tasks assigned to an intelligent agent to perform. It is noted that while the term “task” is used herein, it is appreciated that other things may be assigned to the human, such as higher level goals, outcomes, tactics, or strategies.

The extracted results may be further processed by the analytics component to generate and display reports based on the snapshot data (step 810). For example, in addition to the cumulative ballot results (e.g., as shown in FIG. 6), the reports may include additional statistical information such as time-averaged results or changes over time as described elsewhere in this disclosure.

In this document, the term “exemplary” is used to mean “an example of”' and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media may include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments may be implemented as devices or modules using hardware circuits, software, or combinations thereof. For example, a hardware circuit implementation may include discrete analog or digital components that are, for example, integrated as part of a printed circuit board. Alternatively, or additionally, the disclosed components or modules may be implemented as an Application Specific Integrated Circuit (ASIC) or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C.

The embodiments may further be described using the following clauses:
1. A method for continuous polling of networked users, including:
verifying whether an account associated with a user device has access to a poll;
on a condition that the account is verified, granting the account access to a ballot, wherein the ballot is a copy of the poll specific to the account;
receiving a selection of one or more options in the ballot from the user device;
tallying results of all active ballots at intervals into an aggregated ballot, wherein an active ballot is a most recently submitted ballot of each verified voter; and
storing the aggregated ballot as a snapshot.
2. The method of clause 1, wherein verifying the account includes checking whether the account has a token or certificate to permit access to the poll.
3. The method of clauses 1 or 2, wherein granting the account access to the poll includes sending the ballot to the user device.
4. The method of any one of clauses 1-3, wherein granting the account access to the poll includes permitting the user device to access the ballot, whereby a voter can vote on options in the ballot via the user device.
5. The method of any one of clauses 1-4, wherein:
tallying the results is performed at a predetermined time interval; and
storing the snapshots is performed on the same predetermined time interval after the results are tallied.
6. The method of any one of clauses 1-5, wherein tallying the results includes:
obtaining a token balance for an account associated with each active ballot; and
calculating a point total for each selected option in each active ballot based on the obtained token balance.
7. The method of clause 6, wherein:
each token includes a token voting weight; and
calculating the point total for each selected option is based on the obtained token balance and the token voting weight.
8. The method of clause 7, wherein:
checking voting decay rules associated with the poll; and
adjusting the token voting weight based on the voting decay rules.
9. The method of any one of clauses 6-8, wherein tallying the results further includes determining a rank order of each option in the aggregated ballot based on the calculated point total.
10. The method of any one of clauses 1-9, wherein the snapshot includes metadata, a timestamp, and a hash of all data in the snapshot.
11. The method of clause 10, wherein the snapshot further includes one or more of: a validity proof of the data in the aggregated ballot, an anti-fraud proof of the data in the aggregated ballot, and a completeness proof of the data in the aggregated ballot.
12. The method of any one of clauses 1-11, wherein storing the snapshot includes storing an immutable digital copy of the aggregated ballot.
13. The method of any one of clauses 1-12, wherein the snapshot is stored in an encrypted format.
14. The method of any one of clauses 1-13, further including:
making the snapshot available for viewing.
15. The method of clause 14, wherein:
the poll is configured for public access; and
making the snapshot available for viewing includes making the snapshot publicly available.
16. The method of clause 14, wherein:
the poll is configured for private access; and
making the snapshot available for viewing includes limiting viewing to verified accounts.
17. The method of any one of clauses 1-16, further including:
extracting results data from the snapshot;
providing the results data to an analytics component to create analytics data from the results data; and
making the analytics data available for viewing.
18. The method of any one of clauses 1-17, further including:
extracting results data from the snapshot; and
automatically performing an action based on the extracted results data.
19. The method of any one of clauses 1-18, wherein the poll is configured to implement ranked choice voting.
20. The method of clause 19, wherein each option in the poll has a predetermined number of points.
21. The method of clause 20, wherein the predetermined number of points is based on a total number of options in the poll.
22. The method of clauses 20 or 21, wherein a number of points associated with an option is inversely related to a rank of the option, whereby a first-ranked option has a highest number of points.
23. The method of clause 22, wherein each successively lower-ranked option has a fewer number of points than a preceding higher-ranked option.
24. The method of any one of clauses 20-23, wherein each option left unranked by a voter is assigned a second predetermined number of points.
25. The method of clause 24, wherein the second predetermined number of points is based on a total of the predetermined number of points not assigned to ranked options divided by a number of unranked options, whereby each unranked option is assigned an equal number of points.
26. The method of any one of clauses 1-25, wherein the user device is configured to implement a graphical user interface to display the ballot and enable a voter to rank options.
27. The method of clause 26, wherein the graphical user interface is configured to display each option, a rank of each ranked option, a number of points assigned to each ranked option, and an indicator of each unranked option.
28. The method of clause 27, wherein the poll includes multiple layers.
29. The method of clause 28, wherein the multiple layers includes a hierarchical structure of categories and sub-categories.
30. The method of clause 29, wherein the selection of one or more options includes votes on one or more categories and one or more sub-categories.
31. A method for continuous polling of networked users, including:
granting an account associated with a user device access to a ballot, wherein the ballot is a copy of a poll specific to the account;
receiving a selection of one or more options in the ballot from the user device;
tallying results of all active ballots at intervals into an aggregated ballot, wherein an active ballot is a most recently submitted ballot of each verified voter; and
storing the aggregated ballot as a snapshot.
32. The method of clause 31, further including any one of clauses 2-30.
33. A non-transitory computer-readable medium storing instructions that are

executable by one or more processors of a device to perform operations for continuous polling of networked users, the operations including the operations of any one of clauses 1-32.
34. An apparatus for continuous polling of networked users, including:
a memory storing a set of instructions; and
at least one processor configured to execute the set of instructions to cause the apparatus to perform operations including the operations of any one of clauses 1-32.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, and other embodiments will be apparent to those skilled in the art from consideration of the specification and practice of the technology disclosed herein. It is intended that the specification and examples be considered as exemplary only, with a true scope and spirit of the invention being indicated by the following claims.

What is claimed is:

1. A non-transitory computer-readable medium storing instructions that are executable by one or more processors of a network system to perform operations for continuous polling of networked users, the operations comprising:
verifying whether an account associated with a user device has access to a poll;
on a condition that the account is verified, granting the account access to a ballot, wherein the ballot is a copy of the poll specific to the account;
receiving a selection of one or more options in the ballot from the user device;
tallying results of all active ballots at intervals into an aggregated ballot, wherein an active ballot is a most recently submitted ballot of each verified voter; and
storing the aggregated ballot as a snapshot.

2. The non-transitory computer-readable medium of claim 1, wherein verifying the account includes checking whether the account has a token or certificate to permit access to the poll.

3. The non-transitory computer-readable medium of claim 1, wherein granting the account access to the poll includes sending the ballot to the user device.

4. The non-transitory computer-readable medium of claim 1, wherein granting the account access to the poll includes permitting the user device to access the ballot, whereby a voter can vote on options in the ballot via the user device.

5. The non-transitory computer-readable medium of claim 1, wherein:
tallying the results is performed at a predetermined time interval; and
storing the snapshots is performed on the same predetermined time interval after the results are tallied.

6. The non-transitory computer-readable medium of claim 1, wherein tallying the results includes:
obtaining a token balance for an account associated with each active ballot; and
calculating a point total for each selected option in each active ballot based on the obtained token balance.

7. The non-transitory computer-readable medium of claim 6, wherein:
each token includes a token voting weight; and
calculating the point total for each selected option is based on the obtained token balance and the token voting weight.

8. The non-transitory computer-readable medium of claim 7, wherein:
checking voting decay rules associated with the poll; and
adjusting the token voting weight based on the voting decay rules.

9. The non-transitory computer-readable medium of claim 6, wherein tallying the results further includes determining a rank order of each option in the aggregated ballot based on the calculated point total.

10. The non-transitory computer-readable medium of claim 1, wherein the snapshot includes metadata, a timestamp, and a hash of all data in the snapshot.

11. The non-transitory computer-readable medium of claim 10, wherein the snapshot further includes one or more of: a validity proof of the data in the aggregated ballot, an anti-fraud proof of the data in the aggregated ballot, and a completeness proof of the data in the aggregated ballot.

12. The non-transitory computer-readable medium of claim 1, wherein storing the snapshot includes storing an immutable digital copy of the aggregated ballot.

13. The non-transitory computer-readable medium of claim 1, wherein the operations further comprise:
making the snapshot available for viewing.

14. The non-transitory computer-readable medium of claim 13, wherein:
the poll is configured for public access; and
making the snapshot available for viewing includes making the snapshot publicly available.

15. The non-transitory computer-readable medium of claim 13, wherein:
the poll is configured for private access; and
making the snapshot available for viewing includes limiting viewing to verified accounts.

16. The non-transitory computer-readable medium of claim 1, wherein the operations further comprise:
extracting results data from the snapshot;
providing the results data to an analytics component to create analytics data from the results data; and
making the analytics data available for viewing.

17. The non-transitory computer-readable medium of claim 1, wherein the operations further comprise:
extracting results data from the snapshot; and
automatically performing an action based on the extracted results data.

18. A method for continuous polling of networked users, comprising:
verifying whether an account associated with a user device has access to a poll;
on a condition that the account is verified, granting the account access to a ballot, wherein the ballot is a copy of the poll specific to the account;
receiving a selection of one or more options in the ballot from the user device;
tallying results of all active ballots at intervals into an aggregated ballot, wherein an active ballot is a most recently submitted ballot of each verified voter; and
storing the aggregated ballot as a snapshot.

19. The method of claim 18, wherein verifying the account includes checking whether the account has a token or certificate to permit access to the poll.

20. The method of claim 18, wherein:
each token includes a token voting weight; and
tallying the results includes:
obtaining a token balance for an account associated with each active ballot; and
calculating a point total for each selected option in each active ballot based on the obtained token balance and the token voting weight.
